(19) United States
(12) Patent Application Publication
(10) Pub. No.: US 2020/0396336 A1
(43) Pub. Date: Dec. 17, 2020

(54) NETWORK SYSTEM, SERVER, AND INFORMATION PROCESSING METHOD

(71) Applicant: SHARP KABUSHIKI KAISHA, Osaka (JP)

(72) Inventors: MASAKI TAKEUCHI, Osaka (JP); AKIRA TOJIMA, Osaka (JP)

(21) Appl. No.: 16/898,168

(22) Filed: Jun. 10, 2020

(30) Foreign Application Priority Data
Jun. 17, 2019 (JP) 2019-111960

(51) Int. Cl. H04M 3/51; H04L 12/58; H04M 3/523

(52) U.S. Cl. CPC H04M 3/5183; H04M 3/5166; H04M 3/5133; H04M 3/5232; H04L 51/02

(57) ABSTRACT

A network system is provided to efficiently provide various types of information via a chat using text and voice. The network system includes a first terminal used by a user, a second terminal used by an advisor, and a server configured to automatically conduct a chat with the user using a chatbot, and, in a case where a prescribed condition is satisfied, cause at least one advisor to takeover the chat with the user.

### CROSS-REFERENCE TO RELATED APPLICATIONS

This application claims the benefit of priority to Japanese Patent Application Number 2019-111960 filed on Jun. 17, 2019. The entire contents of the above-identified application are hereby incorporated by reference.

### BACKGROUND

### Technical Field

The disclosure relates to a technology for providing various types of information through a chat using text or voice.

In related art, technologies for making various types of inquiries and providing answers through a website are known. For example, in JP 2003-44487 A, a question-answer system and a server device compatible with the question-answer-system are disclosed. According to JP 2003-44487 A, as part of product support, a website is established on which a user asking a question (a PDA user) and an advisor can exchange questions and answers via the server device. Here, previously acquired question and answer (Q&A) data is published on the Internet, and in addition, a top ten list, which is a list of the question/answer information, and a question list page sorted by category are also created and published on a communication network. Then, when creating the list of question/answer information, the listing order is determined in accordance with the frequency of appearance of a URL entered in the answer information. This allows the list of question/answer information to be published on the basis of the listing order, which constantly and dynamically changes in accordance with a trend in the questions from users.

In addition, in JP 2013-37401 A, a counseling system, a counseling device, a client terminal, and a counseling program are disclosed. According to JP 2013-37401 A, in the counseling system including a client terminal used by a user, a counselor terminal used by a counselor, and a counseling device that manages counseling via the client terminal and the counselor terminal, the counseling device solves the above-described problem by including a voice recognition unit for recognizing the voice of the user and the counselor and converting the voice into text, a video and chat control unit for controlling video and chat content between the user and the counselor, a text summary generation unit for summarizing the text corresponding to counseling content for the user by the counselor, a FAQ information generation unit for generating FAQ information on the basis of the counseling content, and a control unit for controlling at least one of the voice recognition unit, the video and chat control unit, the text summary generation unit, or the FAQ information generation unit.

In recent years, an automatic conversation program using artificial intelligence, called a “chatbot,” has been utilized in various fields. “Chatbot” is a word formed by combining “chat” and “bot.” In applications in which a computer integrated with artificial intelligence engages in conversation on behalf of a human operator, utilization of the “chatbot” has been gradually expanding in call centers and the like, where it is necessary to provide 24-hour support 365 days a year, and also expanding in municipalities and corporations in order to improve the efficiency of their inquiry operations, for example. “Chatbot” is a technology that automatically responds to an inquiry from a user, through automatic answering, which is achieved by FAQ-based artificial intelligence or the like, and the technology is designed such that answers to frequently asked questions, standard inquiries, and the like can be provided automatically without any human intervention.

### SUMMARY

An object of an aspect of the disclosure is to provide various types of information more efficiently through a chat using text or voice.

A network system according to an aspect of the disclosure includes a first terminal used by a user, a second terminal used by an advisor, a server configured to automatically conduct a chat with the user, using a chatbot, and, in a case where a prescribed condition is satisfied, cause at least one advisor to take over the chat with the user.

According to the aspect of the disclosure, various types of information can be provided more efficiently through a chat using text or voice.

### BRIEF DESCRIPTION OF DRAWINGS

The disclosure will be described with reference to the accompanying drawings, wherein like numbers reference like elements.

FIG. 1 is a conceptual diagram of an overall configuration and an operational overview of a network system 1 according to a first embodiment.

FIG. 2 is a conceptual diagram illustrating the operational overview of the network system 1 according to the first embodiment.

FIG. 3 is a conceptual diagram illustrating the operational overview of the network system 1 according to the first embodiment.

FIG. 4 is a conceptual diagram illustrating a screen example of a communication terminal 300 of the network system 1 according to the first embodiment.

FIG. 5 is a conceptual diagram illustrating screen examples of the communication terminal 300 and a communication terminal 200 of the network system 1 according to the first embodiment.

FIG. 6 is a conceptual diagram illustrating screen examples of the communication terminals 300 and 200 of the network system 1 according to the first embodiment.

FIG. 7 is a block diagram illustrating a configuration of the communication terminals 300 and 200 according to the first embodiment.

FIG. 8 is a block diagram illustrating a configuration of a server 100 according to the first embodiment.

FIG. 9 is a block diagram illustrating a configuration of FAQ data 121 according to the first embodiment.

FIG. 10 is a block diagram illustrating a configuration of person-in-charge data 122 according to the first embodiment.

FIG. 11 is a flowchart illustrating a processing procedure of the server 100 according to the first embodiment.

### DESCRIPTION OF EMBODIMENTS

Embodiments of the disclosure will be described below with reference to the drawings. In the following descriptions, identical components are given identical reference signs. Respective names and functions of the components are also identical. Thus, detailed descriptions will not be repeated for the components.

### First Embodiment

### Overall Configuration of Network System 1

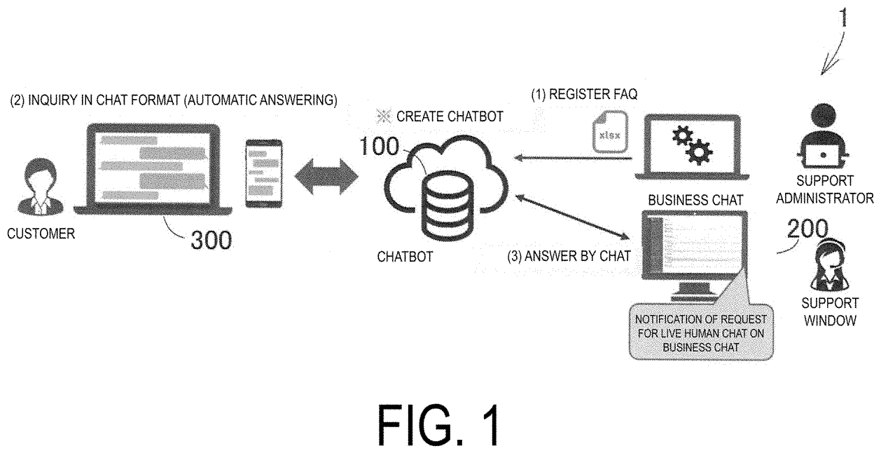

First, with reference to FIG. 1, an overall configuration of the network system 1 will be described. The network system 1 according to the present embodiment mainly includes a server 100 for providing a QA chat service, a communication terminal 300 of a user who uses the QA chat service, and a communication terminal 200 used by an advisor for providing the live human QA chat service.

Note that the server 100 is practically configured by a plurality of devices on the cloud. For example, the server 100 is a concept that includes a server that operates a website, which first accepts an inquiry for the QA chat service and responds to the inquiry using a chatbot, and a server that operates a business chat within a company, a live human QA chat, or the like.

Note that the communication terminals 200 and 300 are practically configured by a smart phone, a tablet, a personal computer, a speaker, or the like, and are capable of communicating with the server 100 via the Internet or a carrier network.

### Operational Overview of Network System 1

Next, with reference to FIG. 1 to FIG. 3, an operational overview of the network system 1 according to the present embodiment will be described.

As illustrated in FIG. 1, first, data including a plurality of combinations of questions relating to products, services, and the like, and answers to those questions are registered in the server 100 in advance (1).

Thereafter, upon accepting a question from the communication terminal 300 of the user, the server 100 runs a QA chatbot. In other words, the server 100 accepts the inquiry from the user via a corporate Web service or the like (2). The server 100 automatically provides the user with an answer corresponding to the inquiry with reference to the FAQ data, while using natural language processing, AI learning, or the like (3).

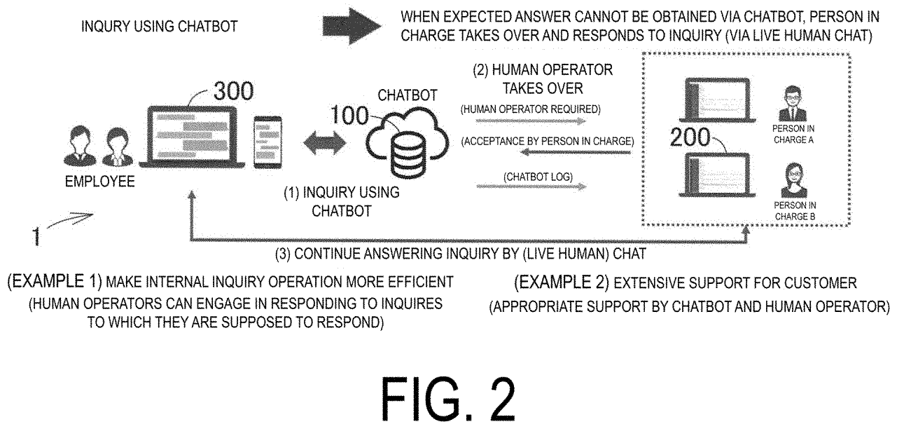

In particular, in the present embodiment, as illustrated in FIG. 2, when the answer by the chatbot is highly unlikely to be an answer expected by the user, the server 100 switches the chat to a live human chat. In other words, the server 100 causes a person in charge to take over, from the chatbot, the role of providing the answer to the question. In the present embodiment, when a prescribed condition is satisfied, the server 100 starts accepting an instruction to cause a human operator to take over the chat.

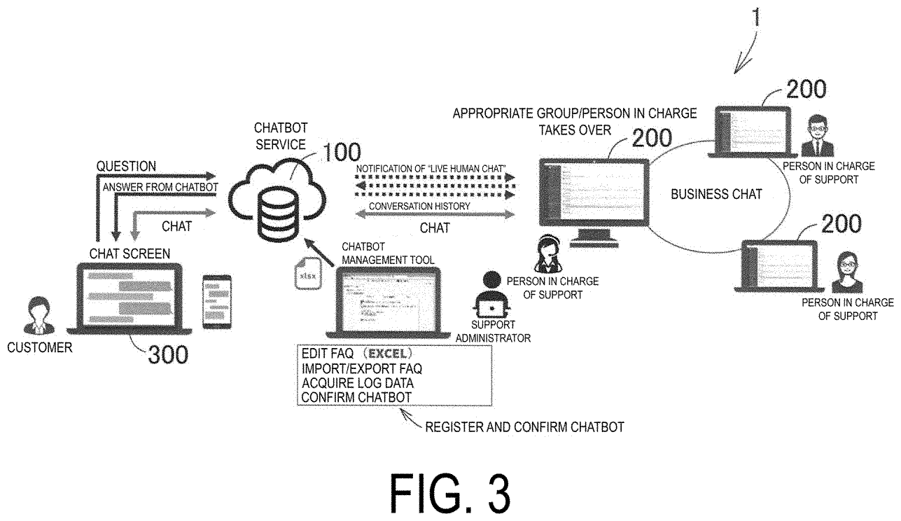

Also, in the present embodiment, as illustrated in FIG. 3, the server 100 sends a notification (makes a report) to a business chat within a company, which includes a person in charge appropriate for the content and field of the question received by the chatbot. The server 100 provides the user with the answer to the question from the advisor, while making it seem as if the user and the person in charge of answering the question are participating in the business chat.

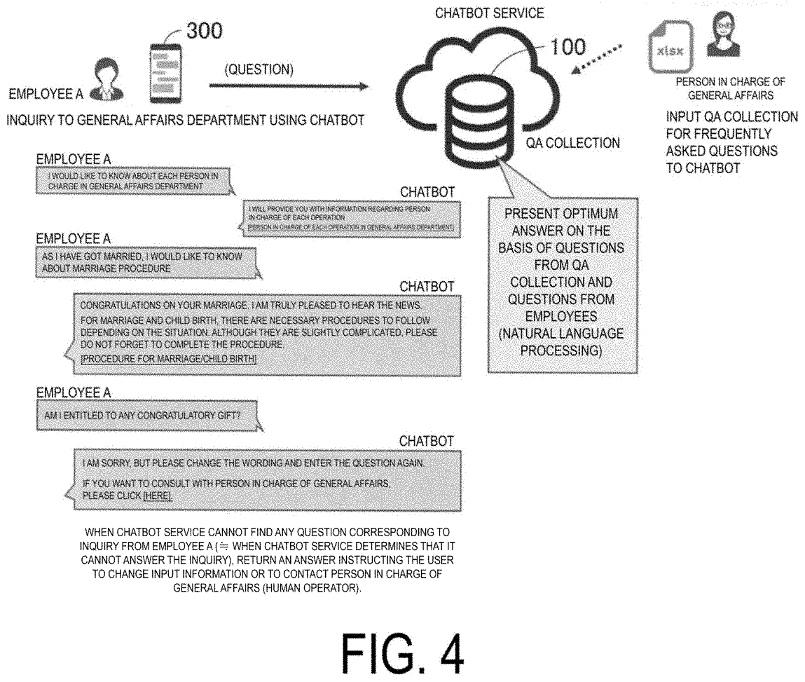

Note that the user may be an external customer having a question regarding a product or a service, or may be an employee using an internal system. For example, as illustrated in FIG. 4, the server 100 may accept a question from an employee A who is the user, and provide an answer using the chatbot. Then, when the server 100 has accepted an unregistered question, or when the server 100 has accepted a prescribed number of responses from the chatbot, for example, five responses, the server 100 causes a button for switching the chat to the live human chat to be displayed on the communication terminal 300.

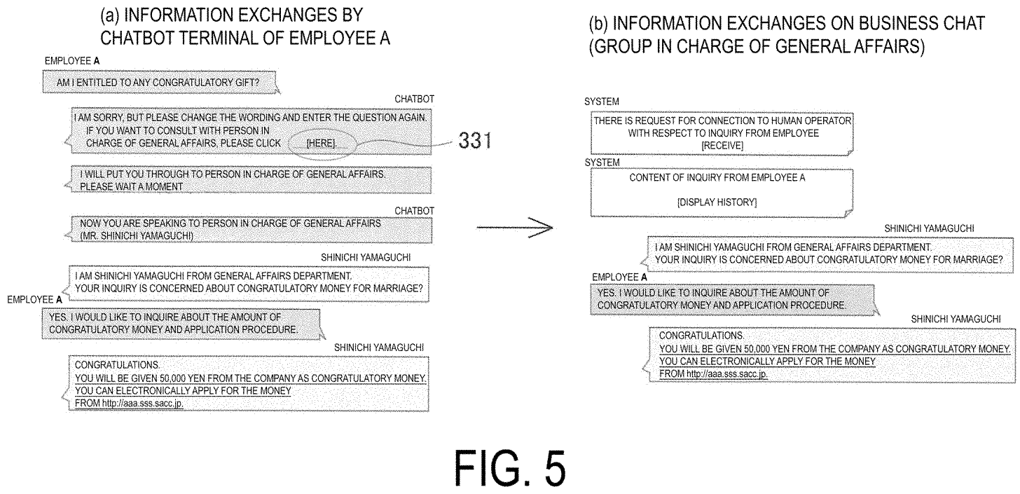

Then, as illustrated in FIG. 5, in a case in which the user wants an answer via the live human chat, the communication terminal 300 accepts a selection command of a button 331 and requests the server 100 to start the live human chat. Upon receiving the request, the server 100 extracts the person in charge of answering the question appropriate for the question concerned, and if the person in charge is available to answer the question, sends a notification (makes a report) to the business chat including the user and the advisor. Note that when the user has posted the question via a website, the chat with the advisor may be started on the website.

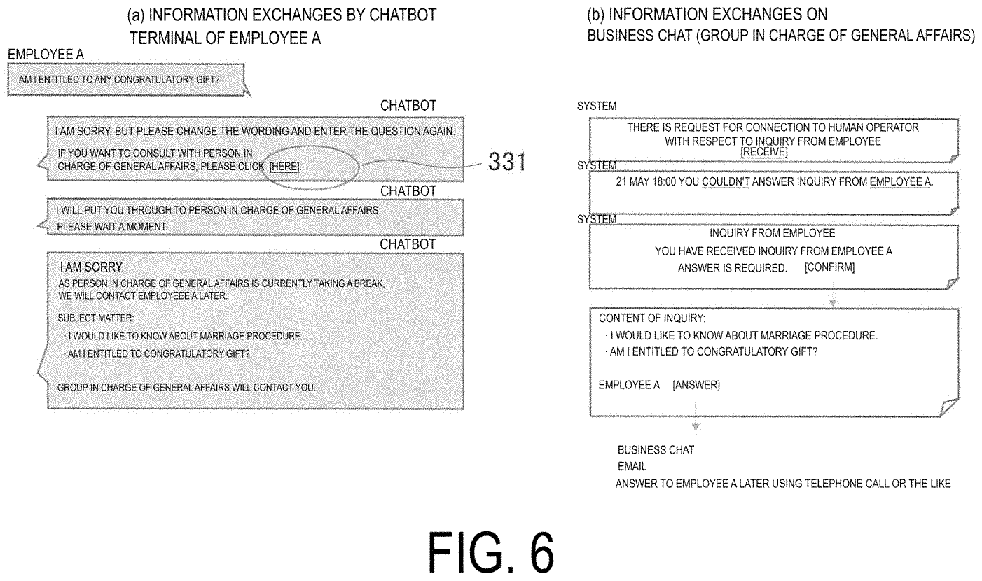

Note that, in the present embodiment, as illustrated in FIG. 6, when the person in charge who is supposed to respond to the question is absent, the communication terminal 300 provides the user with information indicating that the person in charge of answering the question is not currently available, or proposes that the user wait for a contact from the person in charge, for example. In this case, the communication terminal 200 used by the person in charge within the company informs the person in charge of answering the question that the user has made an inquiry in his/her absence.

Hereinafter, a specific configuration of the network system 1 for achieving such a function will be described in detail.

### Configuration of Communication Terminal

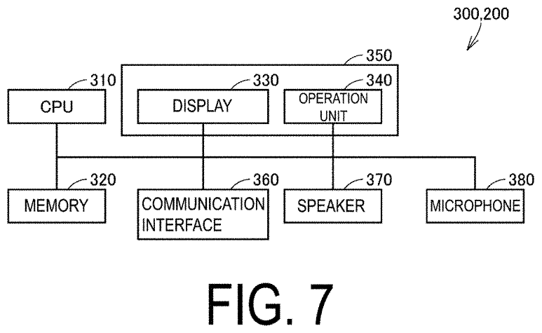

With reference to FIG. 7, one form of a configuration of the communication terminals 300 and 200 configuring the network system 1 will be described. Note that although the communication terminal 300 used by the user will be described below, the configuration of the communication terminal 200 used by the person in charge of answering the question is the same as that of the communication terminal 300.

The communication terminal 300 according to the present embodiment includes a CPU 310, a memory 320, a display 330, an operation unit 340, a communication interface 360, a speaker 370, and a microphone 380 as main components.

The CPU 310 controls each unit of the communication terminal 300 by executing a program stored in the memory 320.

The memory 320 is practically configured by various types of RAM, various types of ROM, and the like. The memory 320 stores application programs for various services, an application program for a QA service, data generated by the CPU 310 executing the programs, data received from the server 100, data input via the operation unit 340, information for identifying the user of the communication terminal 300, and the like.

The display 330 displays images and text on the basis of the data from the CPU 310. The operation unit 340 is configured by a pointing device, a switch, or the like, and allows various types of commands from the user to be input into the CPU 310. Note that the communication terminal 300 of the user may include a touch panel 350 including the display 330 and the operation unit 340.

The communication interface 360 transmits and/or receives data to and/or from other devices, such as the server 100 and the communication terminal 200, via the Internet, the carrier network, a router, or the like. For example, the CPU 310 exchanges various types of information, such as text data and voice data including the questions and answers, with the server 100 via the communication interface 360 in accordance with the application program for the QA service.

For example, the CPU 310 accepts text data of a question via the operation unit 340 in accordance with the application program for the QA service, and transmits the question to the server 100 via the communication interface 360. Then, the CPU 310 accepts, from the server 100, text data of an answer from the chatbot or the live human person in charge, and causes the display 330 to display the answer.

The speaker 370 performs various voice outputs on the basis of signals from the CPU 310. The CPU 310 need not necessarily display the answer using the display 330, but may output the answer accepted from the server 100 using voice.

The microphone 380 accepts the voice and inputs the voice data to the CPU 310. The CPU 310 need not necessarily accept the text data of the question from the operation unit 340, but may accept a voice message from the user and transmit the voice message to the server 100.

The CPU 310 accepts the voice data of the question via the microphone 380 in accordance with the application program for the QA service, and transmits the question to the server 100 via the communication interface 360. Then, the CPU 310 accepts, from the server 100, voice data of the answer from the chatbot or the live human person in charge, and causes the speaker 370 to perform voice output of the answer.

### Configuration of Server

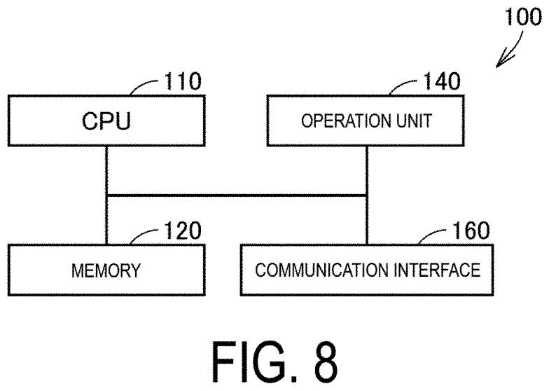

First, one form of a configuration of the server 100 configuring the network system 1 according to the present embodiment will be described. As illustrated in FIG. 8, the server 100 includes a Central Processing Unit (CPU) 110, a memory 120, an operation unit 140, and a communication interface 160 as main components.

The CPU 110 controls each unit of the server 100 by executing programs stored in the memory 120. For example, the CPU 110 performs various types of processing, which will be described below, by executing programs stored in the memory 120 and referring to various types of data.

The memory 120 may be practically configured by various types of RAM, various types of ROM, and the like. The memory 120 may be embedded in the server 100, may be removably attached to various interfaces of the server 100, or may be a recording medium of another device accessible from the server 100. The memory 120 stores the programs that are executed by the CPU 110, data generated as a result of the CPU 110 executing the programs, input data, other databases used for services relating to the present embodiment, and the like. For example, the memory 120 according to the present embodiment stores data used in various types of services.

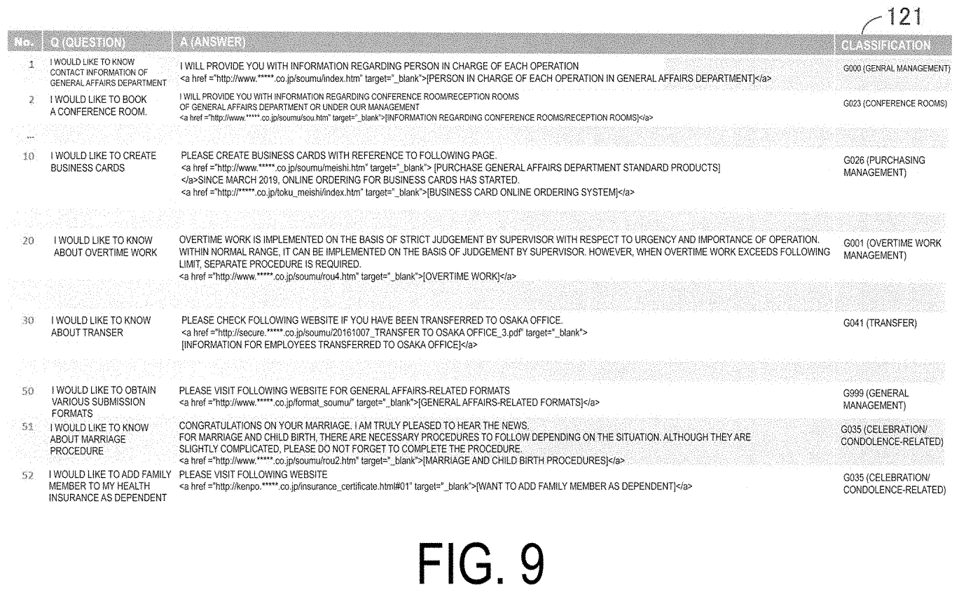

More specifically, as illustrated in FIG. 9, the memory 120 stores FAQ data 121. The FAQ data 121 includes corresponding relationships between identification information of the questions, contents of the questions, contents of the answers, identification information of operations, fields, and departments relating to the questions, and the like. By referring to the FAQ data 121, the CPU 110 can appropriately answer the question from the user, or identify an appropriate department in charge.

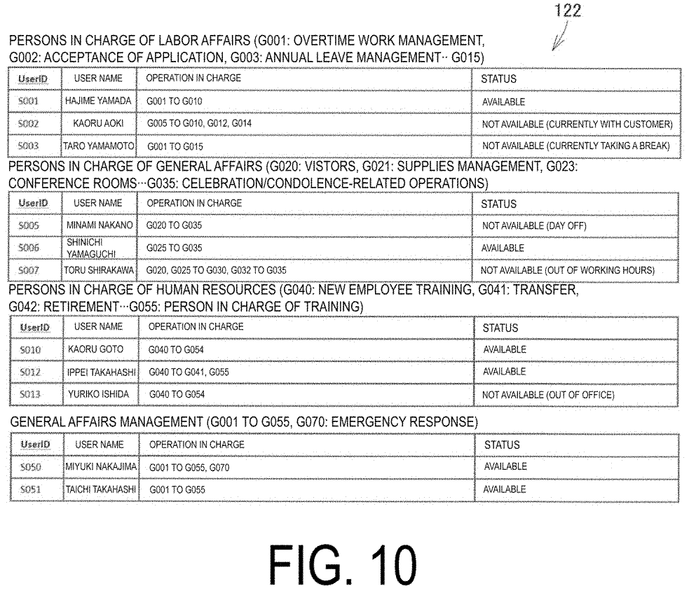

As illustrated in FIG. 10, the memory 120 stores person-in-charge data 122. The person-in-charge data 122 includes corresponding relationship between identification information of the persons in charge, names of the persons in charge, identification information indicating the operations and fields assigned to the persons in charge and departments of the persons in charge, and current statuses of the persons in charge. Note that the current status is information indicating whether the person in charge is available to respond through the live human chat. By referring to the person-in-charge data 122, the CPU 110 can identify the person in charge of the operation relating to the question.

Returning to FIG. 8, the operation unit 140 accepts commands from a service administrator and the like, and inputs the commands to the CPU 110.

The communication interface 160 transmits data from the CPU 110 to other devices such as the communication terminal 300 of the user and the communication terminal 200 of the person in charge of answering the question, via the Internet, the carrier network, the router, or the like. Conversely, the communication interface 160 receives data from the other device, such as the communication terminals 300 and 200, via the Internet, the carrier network, the router, or the like, and sends the data to the CPU 110.

### Information Processing by Server

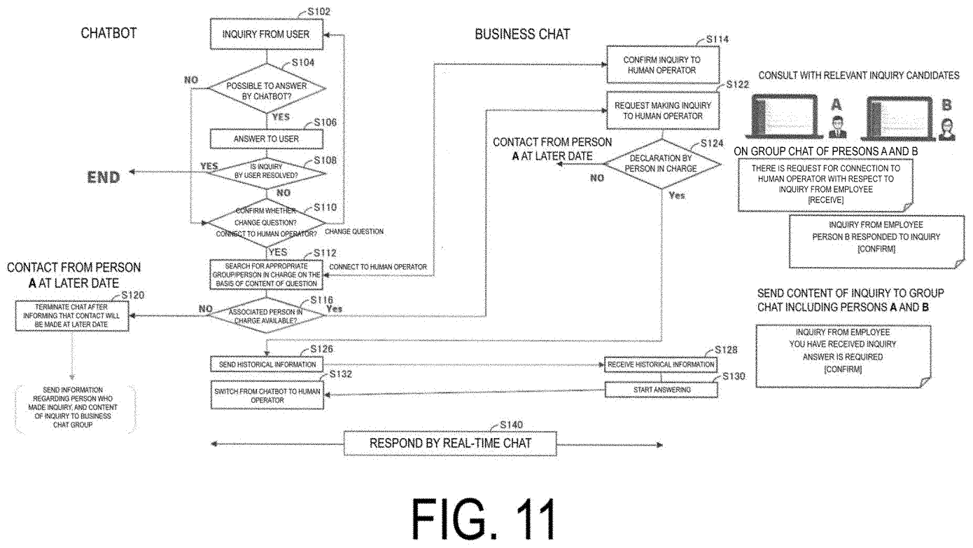

Information processing in the server 100 according to the present embodiment will be described below. Note that, for the purpose of description, a form of the server 100 will be described below in which the single server 100 achieves a function of the chatbot for automatically conducting a chat with the user and a function of operating the business chat used by the person in charge of answering the question. However, both of the functions may be implemented by separate devices, or may be implemented by more than two devices. As illustrated in FIG. 11, the CPU 110 of the server 100 executes the following processing in accordance with the programs stored in the memory 120.

First, the CPU 110 of the server 100 accepts an inquiry from the communication terminal 300 of the user via a website, for example, using the communication interface 160 (step S102).

The CPU 110 refers to the FAQ data 121 to determine whether it is possible to automatically answer the inquiry using the chatbot (step S104). If not possible, the CPU 110 performs the processing from step S110.

If possible, the CPU 110 creates an answer using the chatbot with reference to the FAQ data 121, and transmits the answer data to the communication terminal 300 via the communication interface 160 (step S106).

The CPU 110 queries the communication terminal 300 about whether the problem has been resolved, via the communication interface 160 (step S108). If the problem has been resolved, the CPU 110 terminates the processing relating to the question and answer at this time, and waits for the next inquiry from the communication terminal 300.

If the problem has not been resolved (NO at step S108), the CPU 110 determines whether the prescribed condition is satisfied (step S110). Then, when the prescribed condition is satisfied, the CPU 110 accepts information regarding whether the user wants to have the live human chat. Note that, here, examples of the prescribed condition include a case in which the chatbot has provided the answer three times or more, a case in which the inquiry has been made by a specific user, a case in which a matching rate to the questions stored in the FAQ data 121 is significantly low, and the like.

If the prescribed condition is not satisfied, or if the user does not want to have the live human chat (NO at step S110), the CPU 110 may request, via the communication interface 160, the communication terminal 300 to change wording of the question, and repeats the processing from step S102.

If the prescribed condition is satisfied, or if the user wants to have the live human chat (YES at step S110), the CPU 110 extracts the person in charge appropriate for answering the question from the user (step S112). For example, the CPU 110 identifies the identification information about the operation relevant to the most recent question by referring to the FAQ data 121, and extracts the person in charge to whom the relevant operation is assigned, by referring to the person-in-charge data 122.

The CPU 110 refers to the person-in-charge data 122 to confirm whether the status of the person in charge is “present,” or queries the communication terminal 200 of the person in charge, via the communication interface 160, as to whether the person in charge is available (step S114).

If the person in charge is unable to respond (NO at step S116), via the communication interface 160, the CPU 110 informs the communication terminal 300 of the user who has made the inquiry this time that the person in charge will contact the user later (step S120). Note that at this time, the CPU 110 may query the communication terminal 300 of the user about contact information of the user, via the communication interface 160. Then, the CPU 110 may provide the contact information for the communication terminal 200 of the person in charge of answering the inquiry.

When the person in charge is available (YES at step S116), via the communication interface 160, the CPU 110 requests the person in charge to respond to the user in person using the business chat (step S122). When the person in charge rejects the request to respond via the communication terminal 200 (NO at step S124), the CPU 110 performs the processing at step S120.

When the person in charge declares his/her participation in the business chat in order to provide the answer to the user via the communication terminal 200 (YES at step S124), via the communication interface 160, the CPU 110 provides the communication terminal 200 with a chat history regarding the question concerned between the user and the chatbot (step S126). The communication terminal 200 receives the chat history, and the information is displayed on the display 230 (step S128).

Note that, in the present embodiment, via the communication interface 160, the CPU 110 of the server 100 causes exchanges of messages between the user and the chatbot to be displayed on a screen of the business chat of the communication terminal 200, to make it seem as if the user and the person in charge of answering the question have been having a chat.

As a function of the business chat, via the communication interface 160, the CPU 110 of the server 100 starts a chat between the user of the communication terminal 300 and the live human person in charge of answering the question via a website or the like (step S132), while starting a chat between the person in charge of answering the question and the user via the communication terminal 200 (step S130), as illustrated in FIG. 5.

### Second Embodiment

Note that, in the embodiment described above, at step S112 illustrated in FIG. 11, the CPU 110 extracts the person in charge who is knowledgeable about the field of the most recent question. However, the disclosure is not limited to such an embodiment.

For example, the memory 120 of the server 100 may store identification information of an overall person in charge who responds to the user when the appropriate person in charge associated with all of a plurality of the questions answered by the chatbot, cannot be found. Then, when the prescribed condition is satisfied, and if the user wants to have the live human chat, the CPU 110 searches for the person in charge who is knowledgeable about all the questions made to the chatbot. Then, when the person in charge who is knowledgeable about all the questions made this time cannot be found, the CPU 110 may start the live human chat using the overall person in charge.

Alternatively, at step S112 illustrated in FIG. 11, the CPU 110 may extract the persons in charge who are knowledgeable about each of all the questions made this time. Specifically, the CPU 110 may extract the person in charge who is responsible for the operation relating to the first question, the person in charge who is responsible for the operation relating to the second question . . . , and the person in charge who is responsible for the operation relating to the most recent question. Then, when the prescribed condition is satisfied, and if the user wants to have the live human chat, the CPU 110 may launch the business chat including all the persons in charge concerned. This is because the most recent question is not necessarily the most accurate question.

### Third Embodiment

In the embodiments described above, the user and the advisor conduct the chat mainly using text, but both the user and the advisor may also use the QA service mainly using a voice chat while using the speakers 370 and the microphones 380 of the communication terminals 300 and 200.

### Fourth Embodiment

Some or all of the roles of each of the devices of the network system 1 in the above-described embodiments may be performed by other devices. For example, some or all of the roles of each of the server 100 and the communication terminal 300 may be performed by other devices, or some or all of each of the roles of the devices may be divided and performed by a plurality of devices. For example, some of the roles of the application program of the communication terminals 300 and 200 may be performed by the server 100, or some or all of the roles of the server 100 may be performed by the communication terminals 300 and 200.

Specifically, the CPU 310 of the communication terminal 300 may determine whether the prescribed condition has been satisfied on the basis of a program for the user stored in the memory 320, or HTML data. Then, when exchanges of questions and answers with the chatbot have been repeated three times or more, in accordance with the program, the CPU 310 may cause the touch panel 350 to display the button for starting the live human chat.

### Supplement

In the embodiments described above, a network system is provided that includes a first terminal used by a user, a second terminal used by an advisor, and a server configured to automatically conduct a chat with the user, using a chatbot, and in a case where a prescribed condition is satisfied, cause at least one advisor to take over the chat with the user.

Preferably, in a case where the prescribed condition is satisfied, the server accepts an instruction, from the first terminal, to cause the at least one advisor to take over the chat with the user.

Preferably, among information exchanges of a plurality of the chats conducted by the chatbot, the server selects a single advisor associated with content of an information exchange of the most recent chat.

Preferably, the server selects the at least one advisor associated with each of the information exchanges of the plurality of chats conducted by the chatbot.

Preferably, the server selects an advisor associated with all the information exchanges of the plurality of chats conducted by the chatbot, and in a case where the advisor is not available, selects a prescribed advisor.

Preferably, a current status is associated with each of a plurality of the advisors. The server selects the at least one advisor on the basis of the current status.

Preferably, a current status is associated with each of a plurality of the advisors. In a case where the advisor capable of taking over the chat with the user is not present, the server informs the first terminal that the at least one advisor conducts the chat with the user later.

Preferably, the server causes content of the chat conducted by the chatbot to be displayed to the at least advisor who takes over the chat with the user.

In the embodiments described above, a server is provided that includes a communication interface configured to communicate with a first terminal used by a user and a second terminal used by an advisor and a processor. The processor automatically conducts a chat with the user, using the chatbot, and in a case where a prescribed condition is satisfied, causes at least one advisor to take over the chat with the user.

In the embodiments described above, an information processing method is provided that is achieved by a server capable of communicating with a first terminal used by a user and a second terminal used by an advisor. The information processing method includes automatically conducting a chat with the user, using a chatbot, and causing at least one advisor to take over the chat with the user in a case where a prescribed condition is satisfied.

In the embodiments described above, a program for a communication terminal provided with a communication interface and a processor is provided. The program causes the processor to perform processes including conducting a chat with a user, using a chatbot, via the communication interface, and causing at least one advisor to take over the chat with the user in a case where a prescribed condition is satisfied, via the communication interface.

The embodiments disclosed here are to be understood as being in all ways exemplary and in no ways limiting. The scope of the disclosure is defined not by the foregoing descriptions but by the appended claims, and is intended to include all changes equivalent in meaning and scope to the claims.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. A network system comprising:
a first terminal used by a user;
a second terminal used by an advisor; and
a server configured to automatically conduct a chat with the user, using a chatbot, and in a case where a prescribed condition is satisfied, cause at least one advisor to take over the chat with the user.

2. The network system according to claim 1,
wherein, in a case where the prescribed condition is satisfied, the server accepts an instruction, from the first terminal, to cause the at least one advisor to take over the chat with the user.

3. The network system according to claim 1,
wherein, among information exchanges of a plurality of the chats conducted by the chatbot, the server selects a single advisor associated with content of an information exchange of the most recent chat.

4. The network system according to claim 1,
wherein the server selects the at least one advisor associated with each of information exchanges of a plurality of chats conducted by the chatbot.

5. The network system according to claim 1,
wherein the server selects an advisor associated with all information exchanges of a plurality of chats conducted by the chatbot, and in a case where the advisor is not available, selects a prescribed advisor.

6. The network system according to claim 1,
wherein a current status is associated with each of a plurality of the advisors, and
the server selects the at least one advisor on the basis of the current status.

7. The network system according to claim 1,
wherein a current status is associated with each of a plurality of the advisors, and
in a case where an advisor capable of taking over the chat with the user is not present, the server informs the first terminal that the at least one advisor conducts the chat with the user later.

8. The network system according to claim 1,
wherein the server causes content of the chat conducted by the chatbot to be displayed to the at least one advisor who takes over the chat with the user.

9. A server comprising:
a communication interface configured to communicate with a first terminal used by a user and a second terminal used by an advisor; and
a processor,
wherein the processor automatically conducts a chat with the user, using a chatbot, and in a case where a prescribed condition is satisfied, causes at least one advisor to take over the chat with the user.

10. An information processing method achieved by a server capable of communicating with a first terminal used by a user and a second terminal used by an advisor, the information processing method comprising:
automatically conducting a chat with the user, using a chatbot; and
causing at least one advisor to take over the chat with the user in a case where a prescribed condition is satisfied.
